(19) United States
(12) Patent Application Publication
(10) Pub. No.: US 2022/0134661 A1
(43) Pub. Date: May 5, 2022

(54) PLATFORM UNIT, 3D PRINTING DEVICE AND 3D PRINTING PROCESS

(71) Applicants: Brose Fahrzeugteile SE & Co. Kommanditgesellschaft, Würzburg, Würzburg (DE); AIM3D GmbH, Rostock (DE)

(72) Inventors: Stefan BEETZ, Barnin (DE); Clemens LIEBERWIRTH, Rostock (DE); Vincent MORRISON, Krakow am See (DE)

(73) Assignees: Brose Fahrzeugteile SE & Co. Kommanditgesellschaft, Würzburg, Würzburg (DE); AIM3D GmbH, Rostock (DE)

(21) Appl. No.: 17/435,138

(22) PCT Filed: Mar. 4, 2020
(86) PCT No.: PCT/EP2020/055686

§ 371 Date: Aug. 31, 2021

(30) Foreign Application Priority Data
Mar. 5, 2019 (DE) 10 2019 202 939.6

(51) Int. Cl. B29C 64/295; B29C 64/165; B29C 64/245; B33Y 10/00; B33Y 30/00

(52) U.S. Cl. CPC B29C 64/295; B29C 64/165; B29K 2995/0008; B33Y 10/00; B33Y 30/00; B29C 64/245

(57) ABSTRACT

A platform unit for being arranged on a base plate of a 3D printing device, wherein the platform unit defines a printing area for a component to be built up three-dimensionally in layers. The platform unit can be detachably fastened to the base plate and has at least one heating device for heating the printing area and/or at least one removable sintering base plate, which defines at least part of the printing area, and/or at least one magnetizing device for the alignment of magnetic particles printed for the component.

### CROSS-REFERENCE TO RELATED APPLICATIONS

This application is the U.S. National Phase of PCT Application No. PCT/EP2020/055686 filed on Mar. 4, 2020, which claims priority to German Patent Application No. DE 10 2019 202 939.6, filed on Mar. 5, 2019, the disclosures of which are hereby incorporated in their entirety by reference herein.

### TECHNICAL FIELD

The proposed solution relates to a platform unit for a 3D printing device, to a 3D printing device, and to a 3D printing process.

### BACKGROUND

In 3D printing, three-dimensional components are usually constructed in layers of one or more materials. Example materials include plastics, resins, ceramics, and/or metals. In this connection, the so-called fused deposition modeling, or FDM for short, is known, for example. Here, a component or workpiece is constructed in layers from a fusible plastic or a melted material.

### SUMMARY

In the case of previously known 3D printing devices, a replaceable base plate is usually provided on the 3D printing device and its height inside the 3D printing device can be adjusted in order to construct thereon in layers the component to be printed. Such a base plate accordingly generally functions as a printing plate of the 3D printing device that defines a flat printing surface for the three-dimensional component to be printed. Especially in the case of larger 3D printing devices, base plates of this type have relatively large dimensions and are heavy. In these designs, removal of the base plate from the 3D printing device for cleaning is difficult and complicated. Furthermore, base plates known from the prior art typically do not incorporate any additional functions and hence are generally incapable of contributing to a flexible approach to the components to be printed with the 3D printing device. This disclosure proposes one or more solutions that enable an improvement of 3D printing devices and 3D printing processes.

According to an example embodiment, a platform unit is configured to be arranged on a base plate of a 3D printing device and defines a printing surface for a component to be constructed three-dimensionally in layers. The platform unit can be fastened detachably to the base plate. The platform unit may include at least one heating apparatus for heating the printing surface, at least one sintering base plate that can be removed from the platform unit and defines at least a part of the printing surface, and at least one magnetizing apparatus for orienting magnetic particles printed for the component.

Thus, the above example embodiment is based, at least in part, on the fundamental concept of providing a separate platform unit that can be removably fastened on the base plate of the 3D printing device and provides at least one additional function. This additional function may be controlled heating of the printing surface during the 3D printing process, the provision of a sintering base plate which can be delivered to a subsequent sintering process together with the printed component arranged thereon, or magnetization of magnetic particles for the component to be produced, which are printed (some times simultaneously) by the 3D printing device.

By virtue of the detachable fastening of the platform unit to the base plate of the 3D printing device, the platform unit may be removed from the base plate for cleaning, replacement, or the like. This facilitates, for example, the pre-equipping of the platform unit before arrangement on the 3D printing device. Different platform units may be supplied and optionally fastened (depending on the desired additional function) to the base plate. Alternatively or additionally, the platform unit may be provided with equipment having different additional functions. The equipping of the platform unit outside the 3D printing device is also facilitated by the detachable fastening of the platform unit to the base plate.

In some embodiments, the base plate, which supports the platform unit, is fastened detachably to the 3D printing device allow for removal. However, this is optional. Furthermore, the height of the base plate on the 3D printing device can be adjusted in order to enable or at least assist the construction in layers of the component to be produced. The platform unit may form a separately pre-mountable structural unit that is provided for fastening to the base plate.

In an embodiment, the platform unit has at least one guide body configured to mount on a guide apparatus of the base plate in order to mount the platform unit displaceably on the base plate. Such a guide apparatus may have, for example, at least one guide rail on which the at least one guide body of the platform unit can be arranged displaceably in order to be able, when setting up the 3D printing device, to displace in a guided fashion the platform unit, already arranged on the base plate, relative to the base plate along an adjustment path until it is locked in a predetermined end position.

Here, the platform unit may include at least one locking element via which the platform unit can be locked in an end position with the aid of the guide apparatus. For example, the platform unit may be arranged on the guide apparatus of the base plate so that the platform unit is in an extended starting position. Next, the platform unit is then transferred in the guiding direction into the intended end position in which the locking can then be performed with the aid of the at least one locking element.

Alternatively or additionally, at least one latching element, for example, in the form of a latching lug or a latching hook, is provided to electrically connect the platform unit to a power supply and/or an electronic control system of the 3D printing device in an intended end position on the base plate. When the platform unit is mounted on the base plate, the platform unit thus latches to a mating latching element on the base plate via the at least one latching element and establishes an electrically conductive connection, for example, in order to supply the at least one heating apparatus and/or the at least one magnetizing apparatus with power and/or to be able to control via electrical signals the operation of the at least one heating apparatus and the at least one magnetizing apparatus during a 3D printing or similar process.

The at least one latching element of the platform unit may engage with a device-side or base-plate-side mating latching element when the platform unit has been transferred on the base plate into an intended end position. Alternatively, the latching element may be already latched to a mating latching element when the platform unit is arranged on the base plate and thus when transfer of the platform unit into an end position takes place subsequently to this arrangement on the base plate (for example, by being displaced from a starting position with the aid of a base-plate-side guide apparatus).

In an exemplary embodiment, the platform unit includes a base support on which the at least one heating apparatus, the at least one sintering base plate and/or the at least one magnetizing apparatus are fixed. In this connection, it may be provided that the at least one heating apparatus, the at least one removable sintering base plate and/or the at least one magnetizing apparatus can be fixed optionally and thus replaceably on the base support. This may allow the platform unit to be usable in the 3D printing device with or without the at least one heating apparatus, the at least one removable sintering base plate and/or the at least one magnetizing apparatus. This may allow for the base support to be equipped with only one of the three abovementioned components or units or with a plurality of these components/units in the manner of modules.

For example, at least one first (heating) plate is provided to carry the heating apparatus. A second (support) plate carries the sintering base plate and a third (magnetizing) plate that carries the at least one magnetizing apparatus may also be provided. If a plurality of the abovementioned components/units need to be provided on the platform unit, the platform unit is configured such that the first, second, and/or third plates can be arranged above one another, e.g., stacked or layered on top of one another such that all or only some of the proposed additional functions can be supplied on a printing surface supplied by the platform unit during printing with the aid of the 3D printing device. Thus, for example, a sintering base plate can be selectively provided on the platform unit when the component to be printed needs to be delivered to a subsequent sintering process. The removable sintering base plate may simplify the further production process by enabling the sintering base plate, with the component printed hereon, to be separated from the platform unit and delivered to a subsequent sintering process. If no subsequent sintering process is provided, the platform unit may be without a sintering base plate.

A sintering base plate can be made, for example, from a ceramic material. Ceramics are non-magnetic and are advantageous when combining a sintering base plate and a magnetizing apparatus on the platform unit.

As explained above, an embodiment of the platform unit may provide different first, second, and/or third plates to be fixed in different combinations on a base support of the platform unit, i.e., a first (heating) plate carrying the at least one heating apparatus, a second (support) plate carrying the at least one removable sintering base plate, and a third (magnetizing) plate carrying the at least one magnetizing apparatus. A platform unit of this type may be equipped in a modular fashion with different plates in order to be able to flexibly supply different functions on the platform unit, in particular depending on the three-dimensional components to be printed and/or the printing material used for this purpose.

In an embodiment, the base support may have a viewing window (also known as a view) to facilitate replacement of the heating apparatus and/or magnetizing apparatus arranged hereon. The base support may also have at least one plug-in connector, e.g., in the form of a connector socket or a connector plug, for electrical connection to the at least one heating apparatus and/or to the at least one magnetizing apparatus. The heating apparatus and/or the magnetizing apparatus can be connected to a power supply of the 3D printer device and/or an electronic control system of the 3D printing device via the plug-in connector of the base support.

Independently of any ability of the apparatuses and/or plates supplying the additional functions to be replaced, a heating plate can be provided which carries the at least one heating apparatus and is arranged below a magnetizing plate on the platform unit which carries the at least one magnetizing apparatus. The magnetizing plate carrying the magnetizing apparatus is consequently in this embodiment arranged above and hence in particular on a heating plate such that a printing surface of the platform unit which is defined, for example, by the magnetizing plate or an additional plate arranged on the magnetizing plate is heated and a specific magnetic field can be made available for orienting magnetic particles.

The at least one heating apparatus may include a heating wire and/or a heating coil.

The at least one magnetizing apparatus may include a magnetic coil and/or a magnet. For example, a magnet of the magnetizing apparatus may be a permanent magnet or an electromagnet. In an example embodiment, the platform unit has a plurality of replaceable magnetizing plates that can be fixed optionally on the platform unit depending on the component to be produced. These magnetizing plates may differ in the strength of magnets/coils, the number of magnets/coils, and/or the arrangement of the magnets/coils. It may thus be provided, for example, that the platform unit is, depending on which component is to be printed, equipped with another or a plurality of available magnetizing plates via which magnetic particles are oriented differently during the printing process.

The sintering base plate may be provided, for example, on a support plate from which the sintering base plate may be lifted off. For example, the sintering base plate is fixed on the platform unit via the support plate and may be lifted off from this support plate with the printed component situated on the sintering base plate in order to deliver the component with the sintering base plate to a subsequent sintering process. Thus, lifting the component individually is not needed for delivering it for further processing. Instead, the sintering base plate provided for this purpose and on which the printed component is arranged may simply be lifted off.

The sintering base plate is arranged, for example, in a mounting opening of the support plate. A development hereby provides that the sintering base plate arranged in the mounting opening is flush, e.g., has a flush surface, with a peripheral rim of the mounting opening. In this way, at least that part of the support plate includes the rim of the mounting opening may, together with the sintering base plate, form the printing surface within the 3D printing device.

To make it easier to lift the sintering base plate (automatedly or manually) off from the support plate, an embodiment provides at least one recess for a tool to engage with a peripheral plate rim of the sintering base plate and/or on the support plate. Via this recess, the sintering base plate can be lifted off from the support plate with the aid of the tool. For example, the tool is a manually operable or motor-driven (it may also be computer-assisted) adjustable lifting tool. This lifting tool can engage behind the plate rim of the sintering base plate via the recess in order to lift the sintering base plate out of the mounting opening of the support plate and deliver the sintering base plate with the printed component arranged hereon to a subsequent processing process.

The proposed solution of course also includes a 3D printing device for constructing a three-dimensional component in layers with at least one proposed platform unit.

Independently thereof, a further aspect of the proposed solution provides a 3D printing device that includes at least one magnetizing apparatus for orienting magnetic particles printed for the component on a printing surface of the 3D printing device.

The 3D printer device proposed according to this aspect has a corresponding magnetizing apparatus, irrespective of whether such a magnetizing apparatus is or is not provided on an additionally provided platform unit. Accordingly, an embodiment is, for example, also included in which at least one magnetizing apparatus is provided on a base plate of the 3D printing device. A corresponding magnetizing apparatus may include at least one magnet and/or at least one coil for the targeted orientation of magnetic particles in the printing material present on a printing surface of the 3D printing device for forming the component.

A further aspect relates to a process for constructing a three-dimensional component in layers on a printing surface of a 3D printing device in which it is provided that magnetic particles that are printed for the component are oriented on the printing surface with the aid of at least one magnetizing apparatus.

A corresponding printing process may be implemented with a proposed 3D printing device, for example, using an embodiment of a proposed platform unit, but also independently thereof.

In an example embodiment of a proposed printing process, printed magnetic particles are present in an at least partially liquid binding agent of a printing material for the component to be constructed when the printed magnetic particles are oriented on the printing surface with the aid of the at least one magnetizing apparatus. The printing material with the magnetic particles present in its binding agent is thus applied to the printing surface, where targeted orientation of the magnetic particles takes place via the magnetizing apparatus and a magnetic field generated therewith at an early stage in the printing process in order to establish predetermined magnetizing effects on the component produced.

The different aspects of the proposed solution as explained above may be readily combined with one another such that advantages and features which are mentioned above and below for a specific aspect also apply for correspondingly formed embodiments of another aspect.

### BRIEF DESCRIPTION OF THE DRAWINGS

The attached drawings illustrate possible embodiments, shown by way of example, of the proposed solution.

FIGS. 1A-1B show different views of an embodiment of a proposed platform unit with a heating plate, carrying a heating apparatus, on a base plate for a 3D printer device;

FIG. 2 shows a plan view of the platform unit with no heating plate;

FIGS. 3A-3B show different views of the platform unit in FIGS. 1A and 1B with a magnetizing plate carrying a plurality of magnets and a coil of a magnetizing apparatus;

FIG. 3C shows, on an enlarged scale, the platform unit from FIGS. 3A and 3B with a print nozzle via which magnetic printing material is applied in strands;

FIG. 4 shows a plan view of a platform unit with a support plate carrying a removable sintering base plate;

FIG. 5 shows a perspective view of the platform unit from FIGS. 1A to 4 in an extended (starting) position on the base plate;

FIG. 6 shows a perspective view of an exemplary 3D printing device in which a platform unit from FIGS. 1A to 5 is used.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

To produce the respective component in layers, printing material is applied to a base plate via at least one print nozzle of a 3D printing device, for example in the form of a so-called 3D printer. The respective component is thus constructed in layers, in a computer-aided fashion, by the printing material emerging from the print nozzle. See, for example, WO 2018/039261 A1.

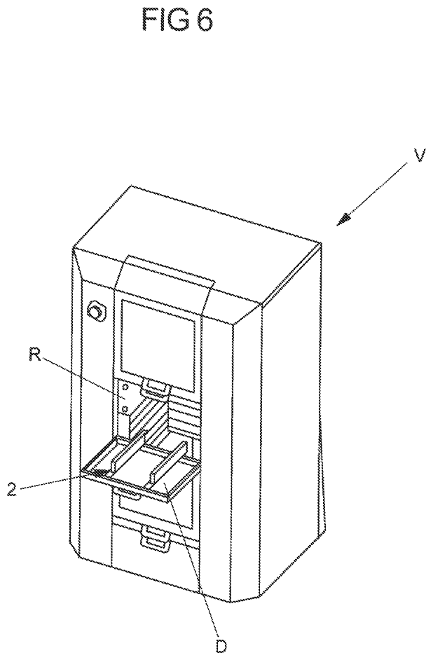

FIG. 6 shows a perspective view of a 3D printing device V, for example, in the form of a so-called 3D printer, for constructing a component in layers inside a printing space R of the 3D printing device. In the course of an additive manufacturing process implemented by the 3D printing device V, a three-dimensional component can be constructed in layers on a base plate D of the 3D printing device. For example, so-called fused deposition modeling (FDM) may be implemented with the 3D printing device.

In the case of the base plate of the 3D printing device V in FIG. 6, a guide apparatus 2 is provided in order to be able to detachably fasten a separate platform unit 1 thereon. The platform unit (not shown in FIG. 6) can thus be arranged and then displaced into an end position via the guide apparatus 2. In this way, a printing surface F, on which the three-dimensional component is constructed in layers inside the printing space R, is finally defined on the platform unit 1 fastened detachably on the base plate D.

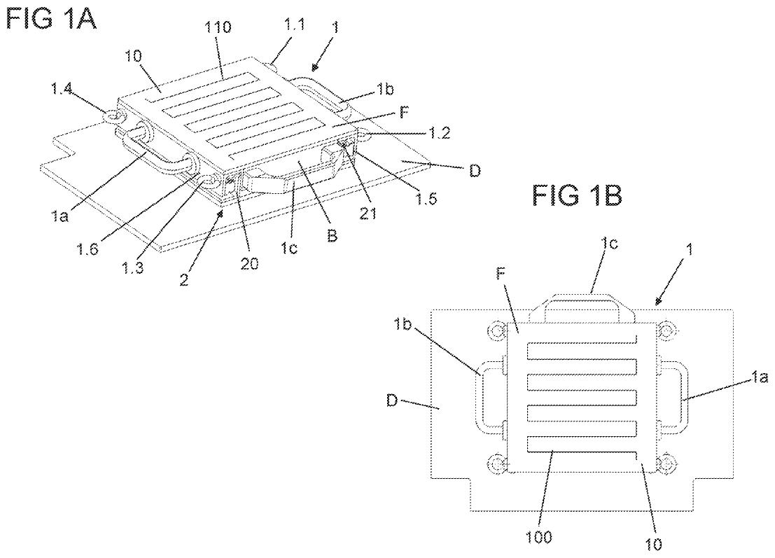

FIGS. 1A to 5 here show differently equipped embodiments of a platform unit 1 to be attached to the guide apparatus 2 of the base plate D. The platform units 1 in FIGS. 1A-1B, 2, 3A-3C, 4, and 5 can be different embodiments for equipping the same platform unit 1 or be different platform units 1 that may be fixed optionally to the base plate D. Each of the platform units 1 has a base support B via which detachable fastening to the guide apparatus 2 of the base plate D is possible and that may be equipped optionally with different plates 10, 14, and 15 to supply different additional functions.

In the embodiment of FIGS. 1A and 1B, the base support B of the platform unit 1 is shown in an end position on the guide apparatus 2. The base support B is retained displaceably via guide bodies in the form of two guide strips 1.5 and 1.6 on two spaced-apart parallel guide rails 20 and 21 of the guide apparatus 2. In the shown end position, the base support B is locked via laterally accessible locking elements 1.1-1.4. Each guide rail 20, 21 and hence each longitudinal side of the base support B are here associated respectively with two locking elements 1.1, 1.2, or 1.3, 1.4.

In order to displace the base support B on the base plate D, the base support B has a front handle 1c. Force can be manually applied to the latter in order to displace the base support B and hence the whole platform unit 1 between the end position and an extended (starting) position via the guide apparatus 2 of the base plate D. The base support B can be lifted off from the guide apparatus 2 in the extended position via two side handles 1a and 1b of the base support B and hence the whole platform unit 1 can be separated from the base plate D.

In the embodiment of FIGS. 1A and 1B, a heating plate 10 is provided on the base support B. This heating plate 10 defines on its upper side a printing surface F for a component to be printed with the 3D printing device V. A heating apparatus, such as a heating coil 100 or a heating wire, is embedded into the heating plate 10. The heating coil 10 may wind back and forth along the heating plate 10. The printing surface F may be heated in a targeted fashion during the printing process via the heating coil 100 in order, for example, to assist the adhesion of a newly applied layer of printing material to an already present layer of printing material, and to maintain the already applied layers of printing material at a specific temperature.

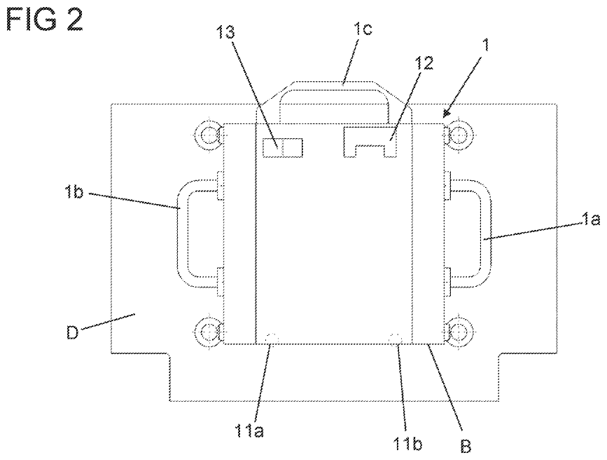

According to the illustration shown in FIG. 2, the base support B may include a plug-in connector 12, e.g., a plug or a socket, on its upper side for the purpose of electrical contacting the heating coil 100 of the heating plate 10. A corresponding plug-in connector on the underside of the heating plate 10 can be plugged hereto when the heating plate 10 is fixed properly on the base support B. As an alternative or in addition to the plug-in connector 12, a differently configured electronic component can also be provided on the base support B in order to enable the control of or supplying of power to (modular) plates, which are to be attached to the base support B. In the embodiment shown, the base support B also has a switch valve 13. This switch valve 13 is provided in an embodiment for a pneumatically controlled locking of a (module) plate on the base support B. This allows a plate arranged on the base support B to be clamped in a vibration-resistant fashion via a pneumatic circuit coupled to the switch valve 13.

Latching elements in the form of latching lugs 11a, 11b can be provided on a rear side, remote from the front handle 1c, of the base support B for latching the base support 1 in the end position on the base plate D and/or for electrical contacting to connect the base support B to a power supply and/or a higher-level electronic control system of the 3D printing device. These latching lugs 11a, 11b engage in a positive-locking fashion in mating latching elements on the base plate D when the base support B has been displaced into the end position on the base plate D.

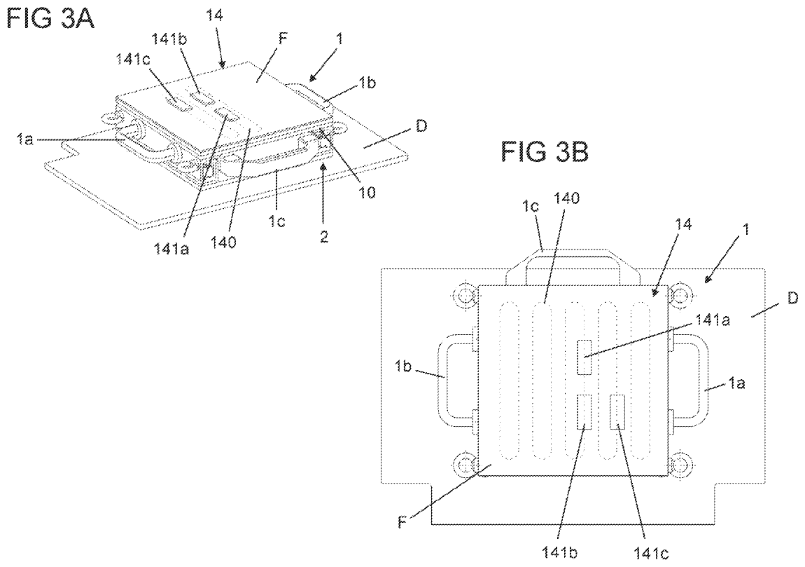

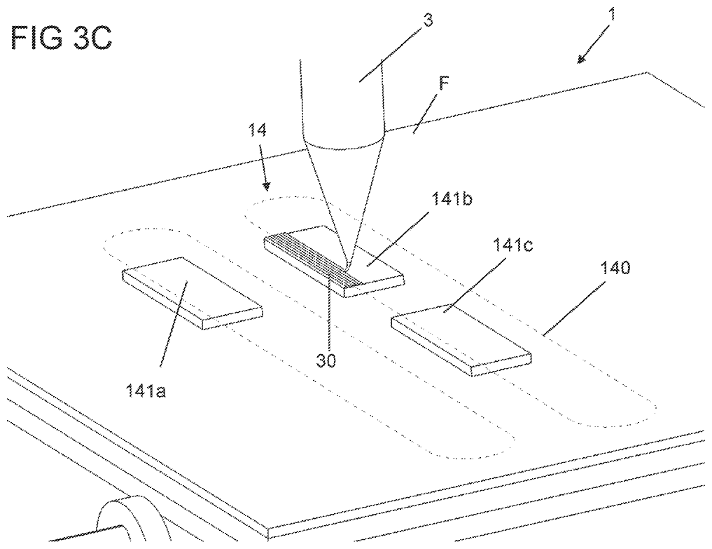

In the embodiment of FIGS. 3A to 3C, the base support B of the platform unit 1 is equipped with a magnetizing plate 14. This magnetizing plate 14 carries a magnetizing apparatus, that may be formed by a plurality of magnets 141a, 141b, 141c and a coil 140. The plurality of magnets 141a to 141c are arranged in a defined pattern on the magnetizing plate 14 and may be electromagnets, permanent magnets, or a combination thereof. During the printing process inside the 3D printing device V, magnetic particles printed on an upper side, defining the printing surface F, of the magnetizing plate 14 can be oriented in a targeted fashion via the magnetizing apparatus 140, 141a-141c of the magnetizing plate 14. Thus, if printing material applied to the printing surface F of the magnetizing plate 14 contains magnetic particles, the latter can be oriented via the magnetizing apparatus 140, 141a-141c in a targeted fashion with the action of the magnetic force of the magnetizing apparatus 140, 141a-141c. For example, it is provided in this connection that simultaneously printed magnetic particles are oriented which are present in a still partially liquid binding agent of the applied printing material.

Because the magnetizing plate 14 can also be readily replaced on the base support B of the platform unit 1, it can also be provided that different magnetizing plates 14 can be optionally (depending on the component to be printed and the magnetic particles to be oriented herein) fixed on the base support B which, for example, differ in the number and/or arrangement of the magnets 141a to 141c provided hereon.

In the embodiments shown in FIGS. 3A, 3B, and 3C, the magnetizing plate 14 is combined with the heating plate 10. The magnetizing plate 14 may be provided above the heating plate 10 such that the magnetizing plate 14 completely covers the heating plate 10 and the printing surface F is defined by the magnetizing plate 14 for the component to be printed. In this embodiment, a plurality of modules in the form of plates 10 and 14 for integrating different additional functions are thus arranged above one another on the base support B of the platform unit 1 and hereby stacked above one another. A printing material applied to the upper side of the magnetizing plate 14 can then hereby, for example, also be heated in a targeted fashion under the action of heat from the heating plate 10.

FIG. 3C shows, at an enlarged scale, the platform unit 1 equipped with the magnetizing plate 14 during the application of printing material 30 containing magnetic particles. The printing material 30 may be applied in strands to the magnetizing plate 14 in the region of a magnet 141b via a print nozzle 3 such that the magnetic particles contained in the printing material 30 can be oriented in a targeted fashion during the printing process via an activated magnet 141b.

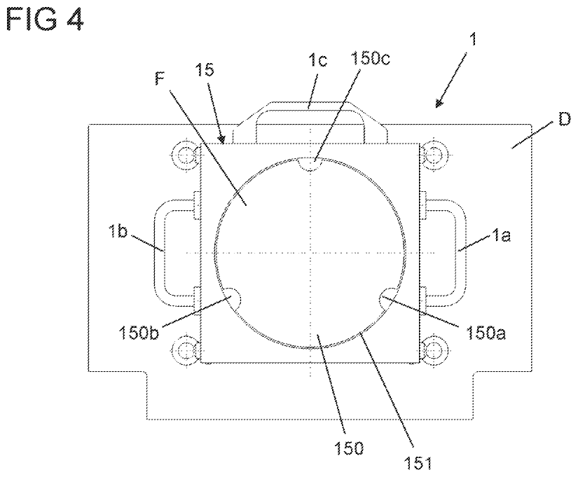

In the case of the platform unit 1 in FIG. 4, a support plate 15 that carries a sintering base plate 150, which can be removed from the platform unit 1, is provided on the base support B. The sintering base plate 150 may be arranged in a mounting opening 151 of the support plate 15 such that an upper side of the sintering base plate 150 that defines the printing surface F has a flush surface with the support plate 15. At the periphery, the sintering base plate has a recess 150a, 150b, or 150c at a plurality of locations (in the present case three) arranged distributed relative to one another. A lifting tool can engage with these recesses 150a-150c on the plate rim of the sintering base plate 150, which takes the form of a circular disk in the present case, and engage behind the recess 150a-150c in order to lift the sintering base plate 150 off manually or automatedly (for example, with the aid of a robot arm) from the support plate 15.

Whilst the recesses 150a-150c are shown in FIG. 4 as having the shape of a segment of a circle in cross-section, the recesses 150a-150c can also have another shape (in cross-section), for example be circular in cross-section. Alternatively or additionally, the support plate 15 can have a recess, or a plurality of recesses, for engagement with a lifting tool on that rim of the mounting opening 151 which faces the sintering base plate 150. When recesses are additionally provided on the support plate 15, it can be provided that the recesses 150a-150c of the sintering base plate 150 are opposite the recesses of the support plate 15 when a predetermined orientation of the sintering base plate 150 is assumed inside the mounting opening 151 in order in this way to make a larger opening available for engagement of the lifting tool.

The sintering base plate 150 is configured and provided for being delivered to a subsequent sintering process. In such a way, a three-dimensional component printed in the printing space R of the 3D printing device V can, together with the sintering base plate, be lifted off from the platform, unit 1 and be delivered to a subsequent sintering process without there being any need for the component to be separated from the platform unit 1 in advance for this purpose and lifted off with the risk of damage.

The support plate 15 with the sintering base plate 150 can hereby in principle be provided individually on the base support B. However, at the same time the support plate 15 can also be combined as a further module plate with one or more module plates in the form of the heating plate 10 or the magnetizing plate 14. It may be provided that is arranged on the base support B below the support plate 15 with the sintering base plate 150 inserted therein, above/on the heating plate 10, above/on the magnetizing plate 14, or above/on a combination of heating plate 10 and magnetizing plate 14. In the embodiment shown of a platform unit 1, the base support B can thus be equipped flexibly in order to integrate different functions on the platform unit 1 depending on the profile of requirements.

The sintering base plate 150 may be made from ceramic. A ceramic sintering base plate 150 offers the advantage of being non-magnetic so that a magnetic field generated by the magnetizing apparatus 140, 141a to 141c of an underlying magnetizing plate 14 is not affected.

Furthermore, the platform unit 1 can be detached as a whole from the base plate D in order to be able to premount the platform unit 1 as a separate structural unit and attach it to the base plate D only later. Via the platform unit 1, not only is it thus possible to make the printing processes which can be implemented with the 3D printing device V flexible, but also the equipping of the 3D printing device V is consequently considerably facilitated.

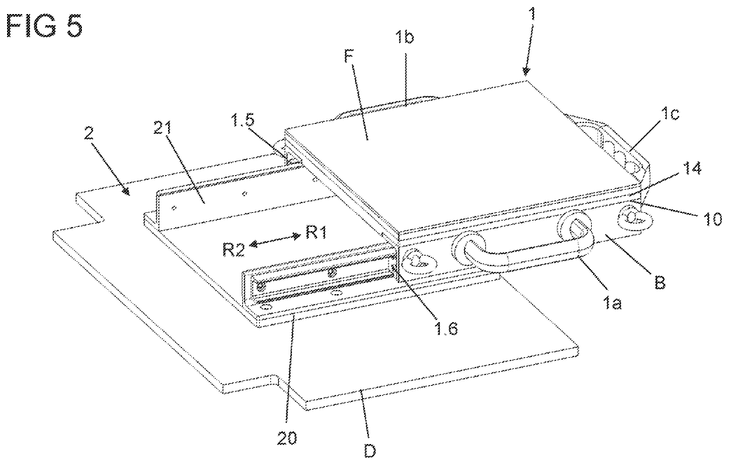

The platform unit 1 is shown in FIG. 5 in the extended position on the base plate D. In the extended position, the platform unit 1 can be removed from the guide apparatus 2. In contrast, for transfer into an intended end position corresponding to FIGS. 1A to 4, the platform unit 1 can be displaced along the guide rails 20 and 21.

Removal of a printed component from a printing surface F supplied by the platform unit 1 is also facilitated by the displaceable mounting of the platform unit 1 on the base plate D. The platform unit 1 may be displaced longitudinally in two opposed adjustment directions R1 and R2 via its base support B retained displaceably on the guide rails 20 and 21 of the guide apparatus 2. The platform unit 1 by be displaced in the adjustment direction R1 into the extended position by being pulled by the front handle 1c. As a result, the platform unit 1 is shifted outside the printing space R.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF DESIGNATIONS

1 platform unit

1a, 1b (side) handle

1c front handle

1.1, 1.2, 1.3, 1.4 locking element

1.5, 1.6 guide body

10 heating plate

100 heating coil (heating apparatus)

11a, 11b latching lug (latching element)

12 electronic component/plug-in connector

13 switch valve

14 magnetizing plate

140 coil

141a, 141b, 141c magnet

15 support plate

150 sintering base plate

150a, 150b, 150c recess

151 plate opening

2 guide apparatus

20, 21 guide rail

3 print nozzle

30 printing material

B base support

D printing plate/base plate

F printing surface

R printing space

R1, R2 direction

V 3D printing device

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A platform unit detachably fastened on a base plate of a 3D printing device, the platform unit comprising:
a printing surface configured to support a component to be constructed three-dimensionally in layers; and
at least one heating apparatus configured to heat the printing surface, at least one removable sintering base plate defining at least a part of the printing surface, or at least one magnetizing apparatus configured to orient magnetic particles applied to the printing surface.

2. The platform unit as claimed in claim 1, wherein the platform unit forms a separately pre-mountable structural unit provided for fastening to the base plate.

3. The platform unit as claimed in claim 1, further comprising at least one guide body configured to mount on a guide apparatus of the base plate in order to mount the platform unit displaceably on the base plate.

4. The platform unit as claimed in claim 3, further comprising at least one locking element configured to cooperate with guide apparatus to lock the platform unit in an end position.

5. The platform unit as claimed in claim 4, wherein in the least one latching element is electrically connected to a power supply and/or an electronic control system of the 3D printing device when the platform unit is in the end position.

6. The platform unit as claimed in claim 1 further comprising a base support, wherein the at least one heating apparatus, the at least one sintering base plate, or the at least one magnetizing apparatus are fixed to the base support.

7. The platform unit as claimed in claim 6, wherein in the at least one heating apparatus, the at least one removable sintering base plate, or the at least one magnetizing apparatus are fixed on the base support such that the platform unit can be used in the 3D printing device with and without one or more of the at least one heating apparatus, the at least one removable sintering base plate, and the at least one magnetizing apparatus.

8. The platform unit as claimed in claim 6, wherein the base support has at least one plug-in connector for an electrical connection to the at least one heating apparatus to the at least one magnetizing apparatus.

9. The platform unit as claimed in claim 1, wherein the heating apparatus has a heating plate and the magnetizing apparatus has a magnetizing plate, wherein the heating plate is arranged below the magnetizing plate on the platform unit.

10. The platform unit as claimed in claim 9, wherein the heating apparatus further has a heating element.

11. The platform unit as claimed in claim 10, wherein the magnetizing apparatus further has a magnetic coil or a magnet.

12. The platform unit as claimed in claim 1 further comprising a support plate, wherein the sintering base plate is provided on the support plate such that the sintering base plate is removable.

13. The platform unit as claimed in claim 12, wherein the support plate defines a mounting opening and the sintering base plate is received within the mounting opening.

14. The platform unit as claimed in claim 13, wherein the sintering base plate is flush with a peripheral rim of the mounting opening.

15. The platform unit as claimed in claim 14, wherein the sintering base plate defines at least one recess on a periphery of the sintering base plate configured to engage with a tool configured to lift the sintering base plate from the support plate.

16. (canceled)

17. A 3D printing device for constructing a three-dimensional component in layers on a printing surface comprising:
at least one magnetizing apparatus for orienting magnetic particles printed for the component on the printing surface.

18. A process for constructing a three-dimensional component in layers on a printing surface of a 3D printing device, comprising:
applying a printing material having magnetic particles on the printing surface; and
energizing a magnetizing apparatus to orient the magnetic particles on the printing surface.

19. The process as claimed in claim 18, wherein the printing material has a partially liquid binding agent, and the energizing the magnetizing apparatus to orient the magnetic particles occurs prior to curing of the partially liquid binding agent.

20. The 3D printing device of claim 17 further comprising:
a base plate; and
a platform unit detachably fastened to the base plate and supporting the printing surface that is configured to support a component to be constructed three-dimensionally in layers by the printing device and further supporting the at least one magnetizing apparatus, wherein the platform unit includes at least one heating apparatus for heating the printing surface and at least one removable sintering base plate defining at least a part of the printing surface.
